(19) United States
(12) Patent Application Publication
(10) Pub. No.: US 2010/0144228 A1
(43) Pub. Date: Jun. 10, 2010

(54) Nanofibers Having Embedded Particles

(76) Inventors: Kelly D. Branham, Woodstock, GA (US); Joel Brostin, Alpharetta, GA (US); Jennifer A. Kaminski, Roswell, GA (US)

Correspondence Address: KIMBERLY-CLARK WORLDWIDE, INC.;Tara Pohlkotte, 2300 Winchester Rd., NEENAH, WI, 54956, US

(21) Appl. No.: 12/331,252

(22) Filed: Dec. 9, 2008

(51) Int. Cl. D04H 3/00; D02G 3/00; B29C 47/00; B32B 5/16

(52) U.S. Cl. 442/401; 428/396; 428/389; 264/465; 428/323; 977/773

(57) ABSTRACT

The present invention is generally directed to, in one embodiment, a composite electrospun nanofiber being formed of a nanofiber and a particle at least partially embedded within the nanofiber, the particle having a width that is greater than the diameter of the fiber so that at least a portion of the particle is not covered by the nanofiber.

### BACKGROUND OF THE INVENTION

Webs containing nanofibers have recently been explored due to their high pore volume, high surface area to mass ratio, and other characteristics. Nanofibers have been produced by a variety of methods and from many different materials. Most commonly, nanofibers are produced by electrospinning processes. Electrospinning, also known as electrostatic spinning, refers to a technology which produces fibers from a polymer solution or polymer melt using interactions between fluid dynamics, electrically charged surfaces and electrically charged liquids.

Nanofibers offer advantages for filtration, odor absorption and chemical barrier properties, as well as other properties. These properties may be enhanced by the addition of selected particles which may be trapped or retained within a nonwoven web by a binder. While binders can function effectively to retain the particles within the substrate, the binder can interfere with the functionality of individual particles by covering the particles. This reduces the ability of the particles to function as they are intended. The undesirability of using a binder increases when nanofibers are utilized. Hence, there is a challenge to include particles in a web of fibers such as nanofibers while reducing shedding of the particles and maintaining desired levels of particle functionality.

### SUMMARY OF THE INVENTION

The present invention is directed to, in one embodiment, a composite nanofiber that includes an electrospun nanofiber and a particle at least partially embedded within the nanofiber. The width of the particle is greater than the diameter of the electrospun fiber and, in some embodiments, may be at least twice the diameter of the electrospun fiber. In selected embodiments, the ratio of the width of the particle to the average diameter of the fiber may range from about 2 to about 50. In preferred embodiments, the particle that is entrained within the electrospun fiber has an exterior surface of which at least a portion is exposed. The present invention also encompasses webs that include such composite electrospun nanofibers.

Selected embodiments of the present invention are directed to a web formed by the method that includes the steps of providing a polymer solution, dispersing particles into the polymer solution and electrospinning composite nanofibers onto a surface, at least some of the particles being at least partially embedded into the nanofibers.

Additional embodiments may include a substrate that includes a nonwoven web and a plurality of electrospun nanofibers disposed on the nonwoven web, at least one electrospun nanofiber having a particle at least partially embedded within the electrospun nanofiber, the particle having an exterior surface of which at least a portion is exposed.

In particular embodiments, the particle which is embedded in the nanofiber may include a longitudinal axis, the longitudinal axes of the electrospun nanofiber and particle being approximately parallel to or aligned with each other. In other embodiments, the present invention is directed to a method for forming a web that includes such composite electrospun nanofibers. Other features and aspects of the present invention are discussed in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a photomicrograph of a composite nanofiber according to an embodiment of the present invention;

FIG. 2 is a photomicrograph of a composite nanofiber according to another embodiment of the present invention;

FIG. 3 is a photomicrograph of a composite nanofiber according to yet another embodiment of the present invention;

FIG. 4 is a photomicrograph of composite nanofibers according to the present invention as part of a nonwoven web; and

FIG. 5 is a photomicrograph of a composite nanofiber according to an embodiment of the present invention disposed on a spunbond fiber.

### DETAILED DESCRIPTION OF REPRESENTATIVE DRAWINGS

Reference now will be made in detail to various embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention covers such modifications and variations within the scope of the appended claims and their equivalents.

The present invention relates generally to composite nanofibers which include a particle at least partially embedded within an electrospun nanofiber, the particle being larger than the average diameter of the nanofiber. As used herein, an “electrospun nanofiber” is defined as a fiber that is produced by an electrospinning system, and which has a diameter of approximately 10,000 nanometers or less. While the diameter of electrospun fibers may vary widely and include fibers having diameters that may range up to about 10,000 nanometers, it is generally understood that the average diameter of electrospun nanofibers in a web will be in the range of from about 1500 to about 100 nanometers. In other embodiments, the average diameter of electrospun nanofibers may be in the range of from about 1000 to about 200 nanometers.

Unexpectedly, it has been found that particles may be incorporated into nanofibers in a new and unique way, leaving the surface of these particles at least partially open and free of polymer. This allows the particle surface to remain available for uses as intended, such as, for example, the containment or catalysis of vapors and other gaseous contaminants. In addition, these results demonstrate the ability to incorporate relatively small particles into the nonwoven webs while reducing the potential for shedding of particles from the web.

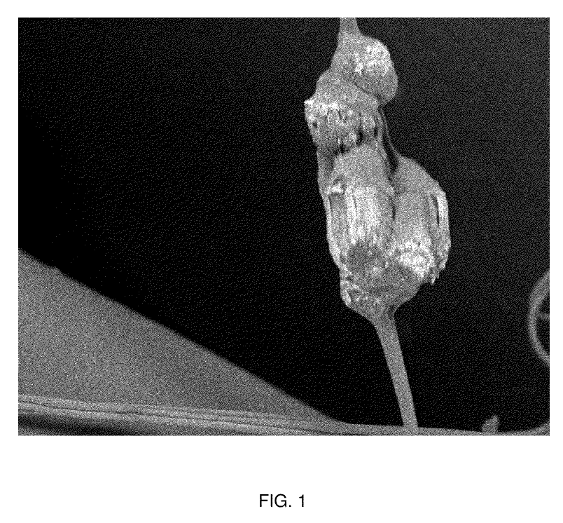

FIGS. 1-5 show scanning electron photomicrographs which demonstrate the unique and unexpected manner in which the particles are incorporated into electrospun nanofibers. The photomicrographs were obtained using the Hitachi S4500 field emission scanning electron microscope (FESEM). Digital images were acquired directly from the electron microscope. Fiber diameter distributions were determined by using Image Pro Plus software from Media Cybernetics.

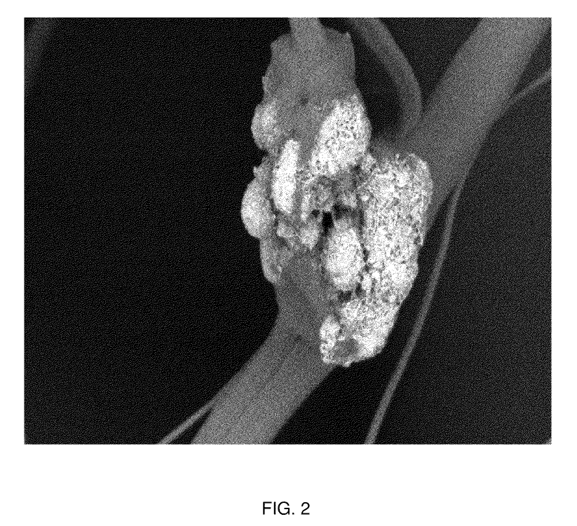

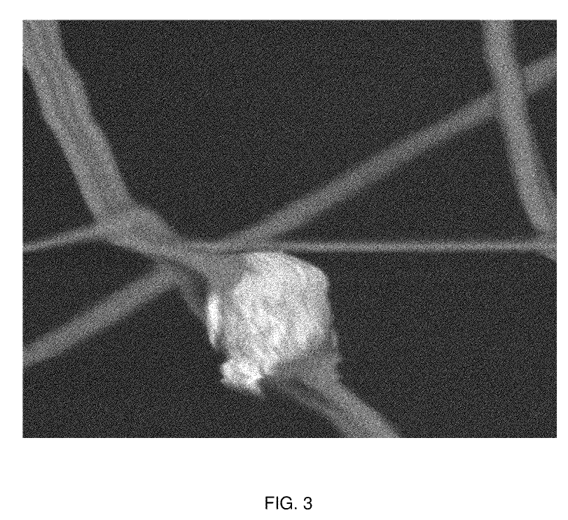

As shown in FIGS. 1, 2 and 3, a particle is embedded or entrained within an electrospun nanofiber to form a composite nanofiber. As used herein, the term “particle” can refer to a single piece or fragment of a substance and is also used to refer to an agglomeration or grouping of pieces or fragments of a substance. For example and as shown in FIGS. 1 and 2, a group of pieces or fragments constitute the particle which is entrained within the electrospun nanofiber. As shown in FIG. 3, a single piece constitutes the particle which is entrained within the electrospun nanofiber.

In each figure, the particle has a width that is larger than the average diameter of the electrospun nanofiber in which it is embedded. As used herein, the “width” dimension of a particle embedded within a fiber is distinguished from its length in that the length of the particle is approximately aligned with the length of the fiber. The width of the particle may be measured at a variety of angles with respect to the length of the fiber, and as used herein is intended to represent the largest width of the particle. FIGS. 1-3 show the tendency of the particles to align such that their length is aligned with the long axis of the nanofiber within which it is embedded.

The particle size may vary across a broad range, from about 3 to about 80 microns. As used herein, “particle size” is intended as the measure of the particle prior to inclusion in the nanofiber. For purposes of illustrating the present invention, particles in the range of 3-8 microns have been utilized.

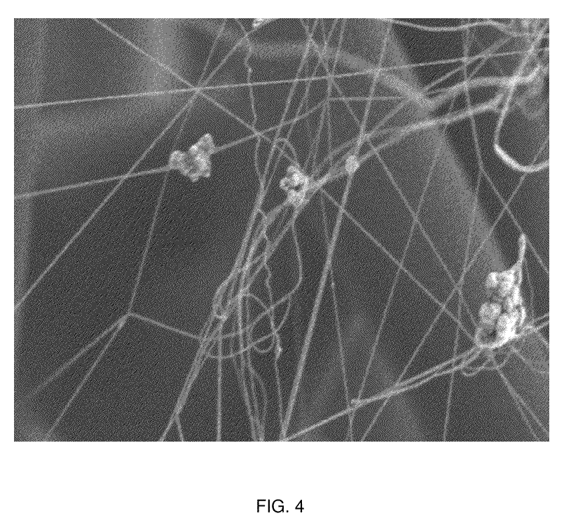

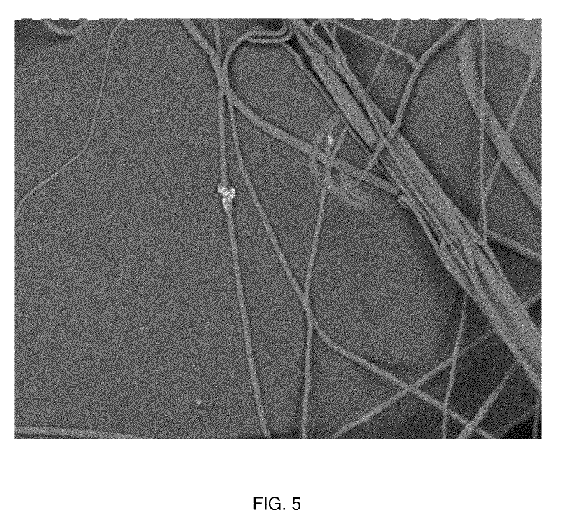

In FIGS. 4 and 5, electrospun nanofibers have been spun onto much larger nonwoven fibers, such as spunbond fibers. Some electrospun nanofibers visible in the photomicrographs have particles at least partially entrained or embedded within them. At least a portion of the surface of the particles is partially free of polymer.

The relative sizes of the electrospun nanofiber and particle influence the ability of the nanofiber to appropriately retain the particle without having the particle fully embedded within the electrospun nanofiber and rendering the particle ineffective for its intended purpose. Particles of diverse sizes, shapes and densities may be combined with electrospun nanofibers formed from a wide assortment of polymers. The relative sizes of the electrospun nanofibers arid particles impacts the ability of the electrospun nanofiber to appropriately retain the particle.

To quantify this relationship, the largest width of the particle that is visible in a photomicrograph may be compared to the average diameter of the electrospun nanofiber within which the particle is embedded. To calculate the average diameter of the nanofiber within which the particle is entrained, at least 10 width measurements are made from the photomicrograph showing the composite electrospun nanofiber. The width measurements are then summed and divided by the total number of width measurements taken. These numbers may be formed into a ratio, the largest width of the particle being divided by the average diameter of the electrospun nanofiber. This ratio may, in selected embodiments, range between a value of greater than 1 to about 50. Ratios above 50 may tend to hinder the ability the electrospun nanofiber to appropriately entrain a sufficient portion of the particle to retain the particle within the nanofiber. In other embodiments, the ratio may range from about 2 to about 40, or from about 3 to about 25.

To approximate the percentage area of the particle which is available or free of polymer from a photomicrograph, the bright areas of the backscattered electron image are detected and isolated so that the total exposed area of the particles can be measured. An outline may be created which estimates the perimeter of the entire particle, some of which may be covered by polymer. Standard image analysis software, such as IMIX by Princeton Gamma Tech, may be used to calculate the areas and determine the percent area of the particle which is free of polymer by dividing the area of the particle which is free of polymer by the estimated area of the particle and multiplying by 100. While this process is inexact, it can provide a rough estimate of the percent area of the particle which is free of polymer. Such an analysis and calculations were performed for FIGS. 2 and 3, which resulted in available areas in the range of from about 30% to about 45%.

The composite electrospun nanofibers may be produced by electrospinning a polymer solution that contains the desired particles, polymeric materials and solvents. The polymeric materials are combined with a solvent to form the polymer solution. A variety of solvents may be used. For example, the solvent and/or solvent system can include, but are not limited to, water, acetic acid, acetone, acetonitrile, alcohol (e.g., methanol, ethanol, propanol, isopropanol, butanol, and the like), dimethyl formamide, alkyl acetate (e.g., ethyl acetate, propyl acetate, butyl acetate, etc.), polyethylene glycols, propylene glycol, butylene glycol, ethoxydiglycol, hexylene glycol, methyl ethyl ketone, or mixtures thereof.

Many different polymer solutions are suited for use in the present invention. For example, such polymers include, but are not limited to, polyolefins, polyethers, polyacrylates, polyesters, polyamides, polyimides, polysiloxanes, polyphosphazines, vinyl homopolymers and copolymers, as well as naturally occurring polymers such cellulose and cellulose ester, natural gums and polysaccharides. Solvents that are known to be useful to dissolve the above polymers for solution electrospinning include, but are not limited to, alkanes, chloroform, ethyl acetate, tetrahydrofuran, dimethyl formamide, dimethyl acetamide, dimethyl sulfoxide, acetonitrile, acetic acid, formic acid, ethanol, propanol, and water.

In particular, polyvinyl alcohol (PVOH) is a polymeric material that is useful in the present invention. Polyvinyl alcohol is a synthetic polymer that may be formed, for instance, by replacing acetate groups in polyvinyl acetate with hydroxyl groups according to a hydrolysis reaction. The basic properties of polyvinyl alcohol depend on its degree of polymerization, degree of hydrolysis, and distribution of hydroxyl groups. In terms of the degree of hydrolysis, polyvinyl alcohol may be produced so as to be fully hydrolyzed (e.g., greater than about 99% hydrolyzed) or partially hydrolyzed. By being partially hydrolyzed, the polyvinyl alcohol may contain vinyl acetate units.

Other ingredients may also be included within the polymer solution to affect the resulting composite electrospun nanofibers. Since the electrospinning process can be performed at room temperatures with aqueous systems, relatively volatile or thermally unstable additives may be included within the nanofibers. Depending on processing or end use requirements, a skilled artisan may employ any or combinations of additives such as, for example, viscosity modifiers, surfactants, plasticizers, and the like.

A variety of electrospinning processes are commonly available, and many publications are available which describe fully the electrospinning process and its controlling variables, such as, for example, solution viscosity, the distance between the spinning tip or roller and the collector, voltage and solution conductivity. In particular, a spinning system referred to as a “Nanospider” system is useful in forming the fibers of the present invention. Elmarco, “Nanospider for Nonwovens”, Technische Textilien 2005, 48.3 (E174) (Ref: World Textile Abstracts 2006), discloses the development of Nanospider spinning technology. A more complete description of this process and equipment are provided in WO 2005/024101A1, which is incorporated herein by reference.

The Nanospider system includes a rotating charged electrode (or roller) that is at least partially immersed in a polymer solution so that a requisite amount of the polymer solution is carried to the peak of the roller. A counter electrode is positioned opposite to the rotating charged electrode so that an electrostatic field is created between the rotating charged electrode and the counter electrode at the peak of the rotating charged roller. The polymer solution is formulated to enable the creation of conical shapes (referred to as Taylor cones) in the thin layer on the surface of the rotating charged electrode. In particular, the electrical conductivity, viscosity, polymer concentration, temperature and surface tension of the polymer solution are controlled to create appropriate spinning conditions.

At a certain voltage range, a fine jet of polymer solution forms at the tip of the Taylor cone and shoots toward the counter electrode. Forces from the electric field accelerate and stretch the jet. This stretching, together with evaporation of solvent molecules, causes the jet diameter to become smaller. As the jet diameter decreases, the charge density increases until electrostatic forces within the polymer overcome the cohesive forces holding the jet together (e.g., surface tension), causing the jet to split or “splay” into a multifilament of polymer nanofibers. The fibers continue to splay until they reach the collector, where they are collected as nanofibers, and are optionally dried. As the fibers approach the grounded collector, the electrical forces cause a whipping affect which results in the nanofibers being spread out onto the collector. A material, such as a nonwoven web, may be positioned between the collector and the tip of the needle to collect the nanofibers.

Many materials may be used as particles of the present invention. For example, materials such as metals, metal oxides, silica, carbon, clay, mica, calcium carbonate, and other materials are suitable for use in the present invention. In particular, Group IB-VIIB metals from the periodic table are useful in the present invention. Metal oxides such as manganese(II,III)oxide (Mn₃O₄), silver(I, III)oxide (AgO), copper(I)oxide (Cu₂O), silver(I)oxide (Ag₂O), copper(II)oxide (CuO), nickel(II)oxide (NiO), aluminum oxide (Al₂O₃), tungsten(II)oxide (W₂O₃), chromium(IV)oxide (CrO₂), manganese(IV)oxide (MnO₂), titanium dioxide (TiO₂), tungsten(IV)oxide (WO₂), vanadium(V)oxide (V₂O₅), chromium trioxide (CrO₃), manganese(VII)oxide, Mn₂O₇), osmium tetroxide (OsO₄) and the like may be useful in the present invention.

As discussed above, the electrospun nanofibers may be formed directly onto a surface of a material such as a film, a woven web or nonwoven web. As used herein the term “nonwoven” fabric or web means a web having a structure of individual fibers or threads which are interlaid, but not in an identifiable manner as in a knitted fabric. Nonwoven fabrics or webs have been formed from many processes such as for example, meltblowing processes, spunbonding processes, bonded carded web processes, etc.

The term “spunbond fibers”, as used herein, refers to small diameter substantially continuous fibers that are formed by extruding a molten thermoplastic material from a plurality of fine, usually circular, capillaries of a spinnerette with the diameter of the extruded fibers then being rapidly reduced as by, for example, eductive drawing and/or other well-known spunbonding mechanisms. The production of spun-bonded nonwoven webs is described and illustrated, for example, in U.S. Pat. No. 4,340,563 to Appel, et al., U.S. Pat. No. 3,692,618 to Dorschner, et al., U.S. Pat. No. 3,802,817 to Matsuki, et al., U.S. Pat. No. 3,338,992 to Kinney, U.S. Pat. No. 3,341,394 to Kinney, U.S. Pat. No. 3,502,763 to Hartman, U.S. Pat. No. 3,502,538 to Petersen, U.S. Pat. No. 3,542,615 to Dobo, et al., and U.S. Pat. No. 5,382,400 to Pike, et al., which are incorporated herein in their entirety by reference thereto for all purposes. Spunbond fibers are generally not tacky when they are deposited onto a collecting surface. Spunbond fibers can sometimes have diameters less than about 40 microns, and are often between about 5 to about 20 microns.

Monocomponent and/or multicomponent fibers may also be used to form the nonwoven web. Monocomponent fibers are generally formed from a polymer or blend of polymers extruded from a single extruder. Multicomponent fibers are generally formed from two or more polymers (e.g., bicomponent fibers) extruded from separate extruders. The polymers may be arranged in substantially constantly positioned distinct zones across the cross-section of the fibers. The components may be arranged in any desired configuration, such as sheath-core, side-by-side, pie, island-in-the-sea, three island, bull's eye, or various other arrangements known in the art. Various methods for forming multicomponent fibers are described in U.S. Pat. No. 4,789,592 to Taniguchi et al. and U.S. Pat. No. 5,336,552 to Strack, et al., U.S. Pat. No. 5,108,820 to Kaneko, et al., U.S. Pat. No. 4,795,668 to Kruege, et al., U.S. Pat. No. 5,382,400 to Pike, et al., U.S. Pat. No. 5,336,552 to Strack, et al., and U.S. Pat. No. 6,200,669 to Marmon, et al., which are incorporated herein in their entirety by reference thereto for all purposes. Multicomponent fibers having various irregular shapes may also be formed, such as described in U.S. Pat. No. 5,277,976 to Hogle, et al., U.S. Pat. No. 5,162,074 to Hills, U.S. Pat. No. 5,466,410 to Hills, U.S. Pat. No. 5,069,970 to Largman, et al., and U.S. Pat. No. 5,057,368 to Largman, et al., which are incorporated herein in their entirety by reference thereto for all purposes.

Suitable multi-layered materials may include, for instance, spunbond-meltblown-spunbond (SMS) laminates and spunbond-meltblown (SM) laminates. Various examples of suitable SMS laminates are described in U.S. Pat. No. 4,041,203 to Brock et al.; U.S. Pat. No. 5,213,881 to Timmons, et al.; U.S. Pat. No. 5,464,688 to Timmons, et al.; U.S. Pat. No. 4,374,888 to Bornslaeger; U.S. Pat. No. 5,169,706 to Collier, et al.; and U.S. Pat. No. 4,766,029 to Brock et al., which are incorporated herein in their entirety by reference thereto for all purposes.

Films useful in the present invention may be mono- or multi-layered films. Multilayer films may be prepared by co-extrusion of the layers, extrusion coating, or by any conventional layering process. Such multilayer films normally contain a base layer and skin layer, but may contain any number of layers desired.

In each of the examples produced in accordance with the present invention, a polymer solution was prepared which included a polyvinyalcohol (PVOH) stock solution containing approximately fifteen percent (15%) solids by weight. One of two PVOH stock solutions was utilized in each of the examples of the present invention. The first, a PVOH, 87-89% hydrolyzed; 85,000-124,000 molecular weight, was purchased from Sigma-Aldrich (Milwaukee, Wis.). The second, Gohsenal T-340, a carboxylic acid-modified polyvinylalcohol (CPVOH), was purchased from Nippon Gohsei (Osaka, Japan). The selected polymer powder was dispersed in water at room temperature with a high speed mixer. The mixture was then placed in a water bath at 70-75° C. and stirred for at least one hour. Clear solutions of completely solubilized polyvinyalcohol were obtained for all examples. The final percent polymer solids was determined on a solids analyzer. Final formulations were made by either diluting the polymer stock solution and adding the desired level of particles by blending with a high speed mixer, or by dispersing the particles into the dilution water and blending the dilution water into the polymer stock with a high speed mixer. Stirring was continued until a homogeneous dispersion was obtained.

While numerous particles may be utilized in the present invention, the examples shown in the figures were produced using Carulite® 400E, which is a manganese dioxide-based catalyst that is commonly used to eliminate ozone. Carulite® 400E was obtained from Carus Corporation (Peru, Ill.). The manufacturer indicates that the particle size of Carulite® 400E is on the order of 3-8 microns in diameter.

The prepared formulations were spun into nanofibers on a Nanospider NS Lab 200S electrospinning unit manufactured by Elmarco (Liberec, Czech Republic). Samples were spun using various electrode configurations provided by the manufacturer. Electrospinning conditions were controlled by adjusting the voltage, electrode spin rate, forming height of the substrate and substrate fabric speed. The nanofibers were captured onto polypropylene spunbond or bicomponent polypropylene/polyethylene spunbond substrates.

The composite electrospun nanofibers shown in FIGS. 1 and 4 were spun from the Gohsenal T-340 PVOH formulation described above using a 6-wire electrode on the Nanospider unit. Both the 6-wire electrode and lamellar electrodes are described more fully in PCT publication WO 2005/024101A1, which is incorporated herein by reference. The composite nanofibers of FIGS. 1 and 4 were spun onto a bicomponent polypropylene-polyethylene spunbond web commercially available under the trade name Intrepid 684L from Kimberly-Clark Corporation.

The composite electrospun nanofiber shown in FIG. 2 was spun from the Sigma-Aldrich PVOH formulation described above using a lamellar electrode on the Nanospider unit. The composite nanofiber shown in FIG. 2 was spun onto a polypropylene spunbond web having a basis weight of 0.4 ounces per square yard (osy) (13.6 gsm). The composite electrospun nanofibers shown in FIGS. 3 and 5 were also spun from the Sigma-Aldrich PVOH formulation described above using a lamellar electrode on the Nanospider unit onto a polypropylene spunbond web having a basis weight of 0.4 osy (13.6 gsm).

As shown in the figures, the electrospinning of a polymer solution containing dispersed particles offers numerous advantages as compared to conventional surface coating of particles onto a nonwoven web or film using a binder.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A composite electrospun nanofiber comprising: an electrospun nanofiber and a particle at least partially embedded within the electrospun nanofiber, the particle having a width that is greater than the diameter of the electrospun nanofiber.

2. The composite electrospun nanofiber of claim 1, wherein the ratio of the width of the particle to the average diameter of the electrospun nanofiber is at least about 2.

3. The composite electrospun nanofiber of claim 2, wherein the ratio of the width of the particle to the average diameter of the electrospun nanofiber is at least about 3.

4. The composite electrospun nanofiber of claim 1, wherein the ratio of the width of the particle to the average diameter of the electrospun nanofiber is less than about 50.

5. The composite electrospun nanofiber of claim 1, the particle having an exterior surface of which at least a portion is not covered by the electrospun nanofiber.

6. The composite electrospun nanofiber of claim 5, at least five percent of the exterior surface of the particle as viewed in a photomicrograph being free of polymer.

7. The composite electrospun nanofiber of claim 1, the particle having a longitudinal axis and the electrospun nanofiber having a longitudinal axis, the longitudinal axes of the electrospun nanofiber and particle being approximately parallel to each other.

8. The composite electrospun nanofiber of claim 1, the particle comprising a metal oxide.

9. The composite electrospun nanofiber of claim 1, the electrospun nanofiber having a diameter of less than about 1500 nanometers.

10. A composite nanofiber comprising: a nanofiber having a diameter, a first end and a second end, and a particle having a width that is greater than the average diameter of the nanofiber, the particle interposed between and attached to the first and second ends of the nanofiber.

11. The composite nanofiber of claim 10, the nanofiber being an electrospun nanofiber.

12. The composite nanofiber of claim 10, wherein the ratio of the width of the particle to the average diameter of the nanofiber is at least about 2.

13. The composite nanofiber of claim 10, the particle having an exterior surface of which at least a portion is exposed.

14. The composite nanofiber of claim 10, the nanofiber having a diameter of less than about 1500 nanometers.

15. A method for forming a web comprising:
providing a polymer solution;
dispersing particles into the polymer solution; and
electrospinning composite nanofibers onto a surface, wherein at least some of the particles are embedded into nanofibers.

16. The method of claim 15, at least some of the particles having an exterior surface of which at least a portion is exposed.

17. The method of claim 15 further comprising the step of providing a collecting substrate.

18. The method of claim 15 wherein the particles have an average diameter of at least about 2 microns.

19. A web formed by the method comprising:
providing a polymer solution;
dispersing particles into the polymer solution; and
electrospinning composite nanofibers onto a surface, wherein at least some of the particles are at least partially embedded into nanofibers.

20. The web of claim 19 wherein the particles have an average diameter of at least about 2 microns.

21. A substrate comprising:
a nonwoven web; and
a plurality of electrospun nanofibers disposed on the nonwoven web, at least one electrospun nanofiber having a particle at least partially embedded within the electrospun nanofiber, the particle having an exterior surface of which at least a portion is exposed.

22. The substrate of claim 15, the nonwoven web comprising a spunbond web and the particles comprising a metal oxide.

23. The substrate of claim 15, the nanofiber having an average diameter of at least about 1500 nanometers.
